(19) United States
(12) Patent Application Publication
(10) Pub. No.: US 2024/0049815 A1
(43) Pub. Date: Feb. 15, 2024

(54) MODULAR REUSABLE RESPIRATORY PROTECTIVE DEVICE

(71) Applicant: Consequent Labs LLC, Tucson (AZ)

(72) Inventor: James Knitter, Tucson, AZ (US)

(21) Appl. No.: 18/267,883

(22) PCT Filed: Dec. 16, 2021
(86) PCT No.: PCT/US21/63651

§ 371 Date: Jun. 16, 2023

Related U.S. Application Data
(60) Provisional application No. 63/127,147, filed on Dec. 17, 2020.

(51) Int. Cl. A41D 13/11

(52) U.S. Cl. CPC A41D 13/1138; A41D 13/1184; A41D 13/1176; A41D 13/1192

(57) ABSTRACT

The respiratory protective device includes a face seal and filter comprising two chambers, an inner chamber and outer chamber. The inner chamber is in fluid communication with the outer chamber, which is in fluid communication with the external environment. The respiratory protective device further comprises a face seal having an open annular-shaped portion, forming a flexible seal by encircling the nose and mouth of a user. The filter sealing ring includes an annular shape that is complementary to an annular-shaped portion of the face seal. The filter sealing ring may detachably mate with the face seal to define a void area. The void area is annular-shaped and suitable to receive a filter having a complementary annular-shaped flange. The shell may sealably and detachably mate with the respiratory protective device. The eye shield may detachably mate with the shell. The seal check apparatus may sealably mate with the respiratory protective device.

### CROSS-REFERENCE TO RELATED APPLICATIONS

This application is a 35 U.S.C. § 371 national stage application of PCT International Application No. PCT/US2021/063651, filed on Dec. 16, 2021, which claims the benefit of U.S. Provisional Application Ser. No. 63/127,147 filed on Dec. 17, 2020, which are hereby incorporated by reference in their entirety.

### BACKGROUND

Various designs of respiratory protective devices are commonly worn by people to reduce breathing in contaminants that may be present in surrounding air. Negative pressure respiratory protection devices commonly form a seal with a user's face around a mouth and nose, creating an inner chamber in communication with a user's respiratory tract. A user's inhalation creates low pressure in an inner chamber of a respirator, causing air to pass through a filter, thereby removing contaminants, and into an inner chamber of a respirator, where cleaned air can continue being inhaled.

Common designs include a disposable molded textile that acts as a filter while also maintaining an overall device structure and forms a sealing surface with a user's face. Other designs include various configurations of a reusable elastomeric facepiece that forms a seal with a user's face, with air drawn through replaceable filter elements. Some designs also prevent users from contaminating air around them by filtering exhaled air which may contain contaminants generated by the user.

One common use for respiratory protective devices is among healthcare workers to prevent infection by breathing in contaminated air or by infecting others by breathing out unfiltered exhaled air. Examples of contaminants include infectious organisms and aerosols. During heightened periods of infectious disease transmission, including public health emergencies such as influenza outbreaks and during global pandemics, including the COVID-19 pandemic, respiratory protection may be needed for prolonged periods of time, and in settings when it is not typically used, including during grocery shopping, air travel, and in general healthcare use. A respiratory protective device that is lightweight, low in profile, and incorporates design elements that facilitate extended reuse with minimal consumable use may help better meet the need for widespread respiratory protection, including during such health emergencies.

### SUMMARY

Accordingly, embodiments of the present disclosure include an improved respiratory protection device comprising: a face seal having an open annular-shaped portion for forming a flexible seal with the face of a user and thereby encircling the nose and mouth of a user; a filter sealing ring having an annular shape that is complementary to an annular-shaped portion of said face seal, said filter sealing ring being capable to detachably mate with said facepiece to define with said facepiece a void area; and said void area being annular-shaped and suitable to receive a filter having a complementary annular-shaped flange.

As embodied and broadly described herein, the invention further seeks to provide a reusable filter having an open annular-shaped portion and dimensions sufficient for encircling a user's mouth and nose, said reusable filter being received in a void area defined between a facepiece and a filter sealing ring of a respiratory protective device.

As embodied and broadly described herein, the invention further seeks to provide a reusable permeable liner that detachably mates with the facepiece and has a complementary shape allowing for close apposition to the internal surface of the filter.

As embodied and broadly described herein, the invention further seeks to provide a protective shell covering the external surface of the filter that detachably mates with the external surface of the facepiece.

As embodied and broadly described herein, the invention further seeks to provide a detachable head harness.

As embodied and broadly described herein, the invention further seeks to provide an impermeable translucent eye shield that mates with the shell.

As embodied and broadly described herein, the invention further seeks to provide a seal check apparatus comprising a conical flanged cover with associated aperture that sealably and detachably mates with the facepiece.

The present disclosure further provides for a negative pressure respiratory protective device, including a facepiece and attached filter creating a single surface comprising a breathable chamber. The chamber is in fluid communication with a user's respiratory tract. Under inhalation, the negative pressure generated by the user breathing in is then communicated to the chamber through the nose or mouth, causing pressure in the chamber to drop and outside air to be drawn across and around the shell, across the filter, and across the liner into the chamber, thereby removing contaminants and allowing the user to breath air in this chamber.

In some embodiments, a respiratory protective device may comprise a first frame having a first body perimeter, the first body perimeter forming a first opening, a second frame having a second body perimeter, the second body perimeter forming a second opening, the second frame being removably attachable to the first frame, a filter having a filter body and a lip portion extending from the filter body, the filter disposed between the first frame and the second frame, wherein a surface of the first perimeter and a surface of the second perimeter engages the lip portion. In some embodiments, the respiratory protective device may further comprise a face seal having a body, the body forming a third opening and a flange extending around the face seal, the face seal attaches to the first frame, wherein the flange is shaped to fit within the opening of the first filter.

In some embodiments, the respiratory protective device may further comprise a shell, having a body with a recessed portion extending along an upper portion of a rear side of the shell, a eye shield having a lip portion formed to engage with the recessed portion of the outer shell and a shell covering attached to a front side of the shell.

In some embodiments, the respiratory protective device may further comprise a filter liner removably attached to an aft interior portion of the filter.

In some embodiments, the first frame and second frame each may further comprise a plurality of connectors spaced about the first and second body perimeter.

In some embodiments, the respiratory protective device may further comprise one or more void spaces formed between the first filter and the outer shell.

In some embodiments, the outer shell may have an interior portion configured to receive an assembled first and second frame.

In some embodiments, the flange may form a recess extending around a perimeter of the face seal body, and a portion of the first frame is configured to couple with the recess to hold the face seal body to the first frame.

In some embodiments, the filter liner may have a body perimeter that couples with a portion of the first frame and the flange of the face seal.

In some embodiments, the shell may further comprise a plurality of apertures formed within the body of the shell thereby allowing fluid communication between an external environment and the first filter.

In some embodiments, a kit for respiratory protective devices may comprise at least one respiratory protective device. The at least one respiratory protective device may further comprise a first frame having a first body perimeter, the first body perimeter forming a first opening, a second frame having a second body perimeter, the second body perimeter forming a second opening, the second frame being removably attachable to the first frame, one or more filters, with each filter having a filter body and a lip portion extending from the filter body, the filter disposed between the first frame and the second frame, wherein a surface of the first perimeter and a surface of the second perimeter engages the lip portion and multiple face seals, wherein each face seal has a body, the body forming a third opening and a flange extending around the face seal, the face seal removably attachable to the first frame, wherein the flange is shaped to fit within the opening of the first filter, and wherein at least two face seals have different body shapes to fit different face sizes, and the flange is the same size for each of the multiple face seals.

In some embodiments, the kit may further comprise one or more filter liners, the filter liner configured to be removably attached to an aft interior portion of the one or more filters.

In some embodiments, the kit may further comprise one or more shells, each shell having a body with a recessed portion extending along an upper portion of a rear aspect of the shell.

In some embodiments, the kit may further comprise one or more eye shields, each eye shield having a lip portion formed to engage with the recessed portion of the shell.

In some embodiments, the kit may further comprise one or more shell coverings attachable to a front side of the shell.

In some embodiments, a respiratory protective device may comprise a facepiece, a first filter, a filter liner, an outer shell and a first chamber, wherein the first chamber comprises a first void space formed by a face of a user, the facepiece and the first filter, wherein the first void space extends from the face of the user to the first filter. The respiratory protective device may further comprise a second chamber, wherein the second chamber comprises a second void space formed between the first filter and the outer shell. The respiratory protective device may further comprise a frame positioned between said first chamber and said second chamber, wherein the frame joins the facepiece to the outer shell and a sealing ring positioned between the frame and the outer shell, wherein the sealing ring holds the first filter in contact with the frame, forming a seal. In some embodiments, the filter liner may be removably attached to the first filter on a surface facing the first chamber, wherein the filter liner is removable while retaining a seal separating the first chamber and the second chamber.

The above summary is not intended to describe each disclosed embodiment or every implementation. The Figures and the Detail Description, which follow, more particularly exemplify illustrative embodiments.

### BRIEF DESCRIPTION OF THE DRAWINGS

The disclosure may be more completely understood by the following detailed description in conjunction with the accompanying drawings, wherein like reference numerals designate like structural elements.

FIG. 1 is a perspective partial exploded view of an exemplary embodiment of a respiratory protective device according to the present disclosure.

FIG. 2 is a perspective view of an exemplary embodiment of a respiratory protective device while worn by a user according to the present disclosure including attached eye shield.

FIG. 3 is a perspective view of an exemplary embodiment of a respiratory protective device while worn by a user according to the present disclosure without attached eye shield.

FIG. 4 is a perspective view of an exemplary embodiment of a respiratory protective device facepiece body with filter and sealing facepiece element.

FIG. 5A is a cross sectional top view of the respiratory protective device shown in FIG. 3.

FIG. 5B is a cross sectional side view of the respiratory protective device shown in FIG. 3.

FIG. 6 is a perspective view of the respiratory protective device shown in FIG. 4 with an illustrative attached seal check apparatus.

### DETAILED DESCRIPTION

Exemplary applications of respiratory protective device assemblies according to the present disclosure are described in this section. Various examples are provided to add context to, and aid in the understanding of, the subject matter of this disclosure. It should be apparent to one having ordinary skill in the art that the present disclosure can be practiced without some or all of these specific details described herein. Further, various modifications and/or alterations can be made to the subject matter described herein and illustrated in the corresponding figures to achieve similar results or similar advantages, without departing from the spirit and scope of the disclosure.

Any scientific and technical terms used hereafter have meanings commonly used in the art unless otherwise specified. The definitions provided are to facilitate understanding of frequently used terms and are not meant to limit the scope of the present disclosure.

Unless otherwise described, any numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a, an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element or elements to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on,” “connected to,” “coupled with,” “in contact with,” “separating,” or “adjacent” another element, component, or layer, it can be directly on, directly connected to, directly coupled with, in direct contact with, or intervening elements, components, or layers may be on, connected, coupled, or in contact with or separating the particular element, component, or layer, for example. When an element, component, or layer for example is referred to as being “directly on,” “directly connected to,” “directly coupled with,” or “directly in contact with” another element, there are no intervening elements, components or layers for example.

As used herein, “have,” “having,” “include,” “including,” “comprise,” “comprising,” or the like are used in their open-ended sense, and generally mean “including, but not limited to.” It will be understood that the terms “consisting of” and “consisting essentially of” are subsumed in the term “comprising,” and the like.

The term “integral” refers to being made at the same time or being incapable of being separated without damaging one or more of the integral parts.

The term “respiratory protective device” refers to a device that is worn by a user to filter air before the air enters the person's respiratory system.

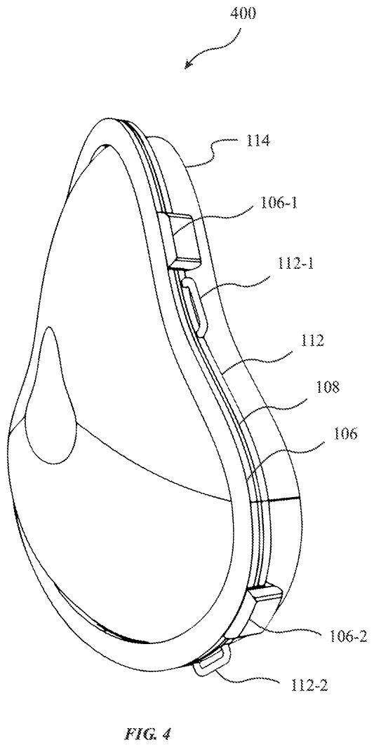

The term “facepiece” refers to the structure that fits at least over the nose and mouth of a person and that helps define an interior air space separated from an exterior air space. The term facepiece may be used herein to describe some of components of the device 100, such as components of 400 depicted in FIG. 4.

The term “face seal” refers to a component that provides a seal to a user's face.

The term “frame” refers to a device that is attachable or integral to a facepiece to interconnect components by way of a semi-rigid structure.

The term “filter” refers to a device that is attachable to a respiratory protective device for purposes of filtering air before it enters the interior air space between a facepiece and a user's face.

The term “filter sealing ring” refers to a device that is removably attached to a respiratory protective device for the purpose of establishing an airtight seal between a filter and facepiece.

The term “shell” refers to a device that is attachable to a respiratory protective device for purposes of protecting the filter from the environment and acting as a prefilter to aid in prolonging useful filter lifespan.

Exemplary applications of respiratory protective device assemblies according to the present disclosure are described in this section. Various examples are provided to add context to, and aid in the understanding of, the subject matter of this disclosure. It should be apparent to one having ordinary skill in the art that the present disclosure can be practiced without some or all of these specific details described herein. Further, various modifications and/or alterations can be made to the subject matter described herein and illustrated in the corresponding figures to achieve similar results or similar advantages, without departing from the spirit and scope of the disclosure.

The present disclosure describes various embodiments of a respiratory protective device having a facepiece and filter comprising two chambers, an inner chamber and outer chamber. The inner chamber is formed by the close apposition and sealing effect of the facepiece to a user's face and extends to the boundary of the reusable filter. The outer chamber is then formed from the extent of the reusable filter to the extent of the shell. Upon a user breathing in, air is drawn across the filter into the inner chamber, which causes air to draw across the shell in the outer chamber, replacing air that was displaced into the inner chamber. Air in the inner chamber can then continue being inhaled by the user. A user's exhaled air likewise passes across the filter and shell and then diffuses into the surrounding environment.

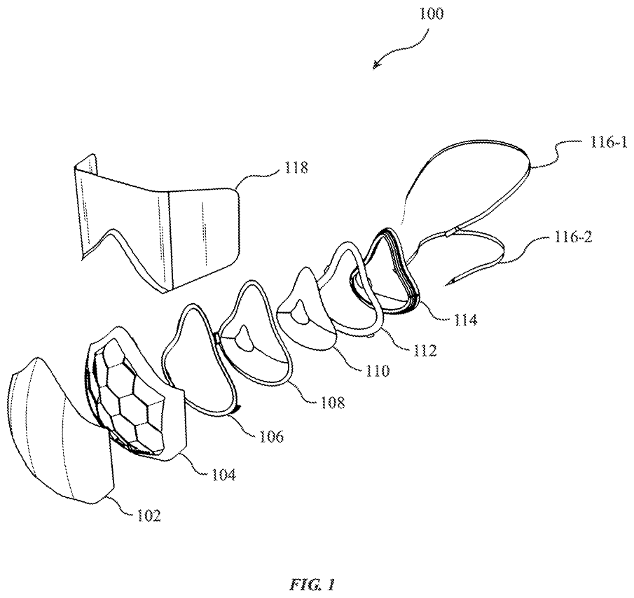

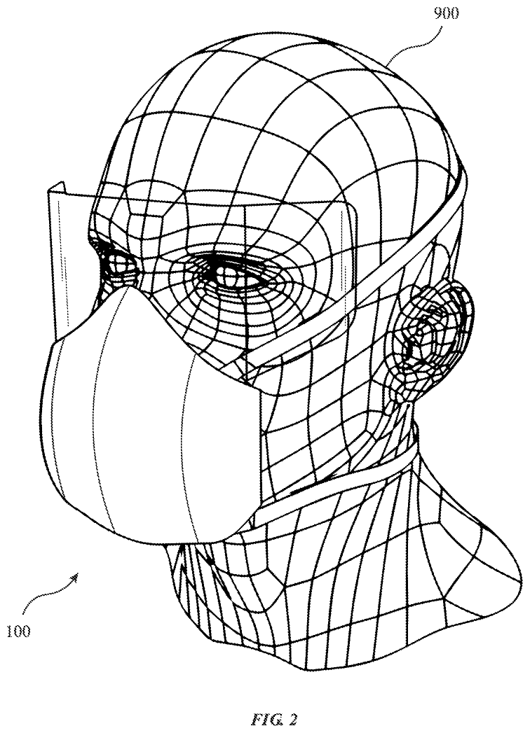

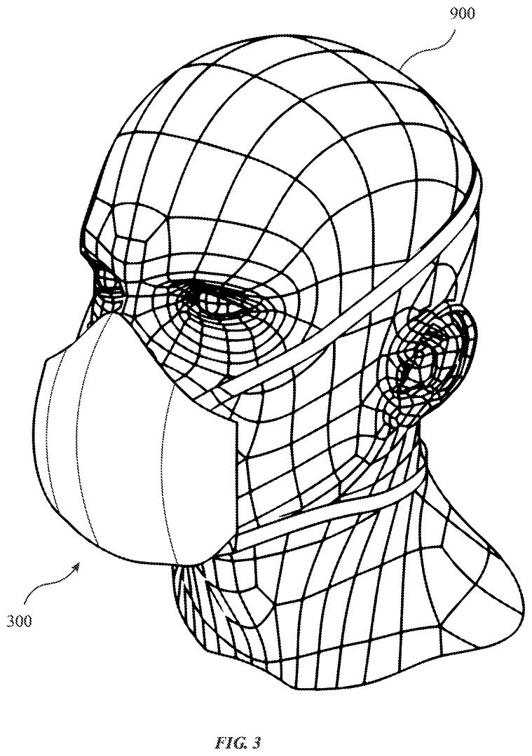

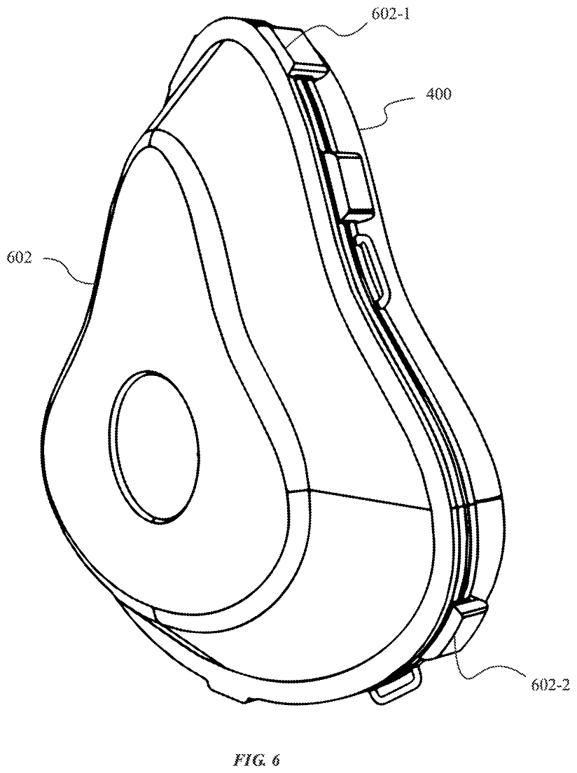

Referring to the drawings, FIGS. 1 to 6 illustrate a respiratory protective device constructed according to an embodiment of the invention which is generally designated with the reference number 100. FIGS. 2 and 3 illustrate respiratory protective device 100 with and without removable eye shield 118. FIG. 6 illustrates a respiratory protective device with attached seal check apparatus 602.

FIG. 1 illustrates an example of a respiratory protective device 100 that may cover the mouth and nose and provide filtered air to a user. The respiratory protective device includes a facepiece comprised of a face seal 114 and frame 112 sealably attached. Filter 108 is sealably attached to a facepiece by way of circumferential filter sealing ring 106. Liner 110 may be formed in close apposition to the inner surface of filter 108 and is removably held by frame 112 and face seal 114. Shell 104 removably attaches to facepiece and may include shell cover 102 affixed to shell. Harness straps 116-1 and 116-2 provide tension between the facepiece and a user's face to closely oppose the face seal and form a seal with a user's face. Eye shield 118 removably attaches to shell 104.

The facepiece may include a rigid or semi-rigid portion 112 and a compliant portion contacting a user's face 114. The compliant portion of the facepiece that contacts the user's face is constructed to allow the facepiece to be supported comfortably over a user's mouth and nose to allow for close apposition with a user's face in order to create a seal with the user's face to prevent the movement of air between the facepiece and a user's face in either an inward or outward direction relative to the user's face. The face seal 114 may have a flexible portion that turns inward toward a user's face in order to provide a larger surface area forming contact with a user's face when worn by a user to facilitate a better seal with a user's face.

In some embodiments, face seal 114 may comprise a user contacting portion and a frame engaging portion. The frame engaging portion of the face seal may be a universal interface of a common attachment geometry or flange configuration to sealably attach to frame 112. The flange may form a recess extending around a perimeter of the face seal body, and a portion of the frame 112 may be configured to couple with the recess to hold the face seal body to the frame. In some embodiments, a plurality of alternate face seals may be interchangeable with face seal 114. Each of the plurality of alternate face seals may comprise identical (or compatible) frame engagement portions attached to different user contacting portions. The user contacting portion of each of the alternate face seals may be of different design, contour profile, size, or combination thereof, as well as may be manufactured from one or more different materials as that of the frame engaging portion. In some embodiments, the face seal 114 may also comprise a transition portion which is configured to provide a seamless, continuous, and smooth transition from the geometry and contour profile to the common frame engaging portion.

In some embodiments, the design, contour profile and sizes may be generated based on one or more user face models. User face models may be synthetically generated, simulated, or averaged from one or more data sets of human faces. In some embodiments, representative face models may be generated for differing demographics. For example, representative models may be generated for differing age ranges, head size, gender, and facial features. In some embodiments, facial features common to people of a geographic region or ethnicity may be used in the generating of user face models. Face seals may be designed based on each of the user face models to provide the best fit possible. The quality of the seal produced when a user wears the respiratory protective device may be improved by matching a user's facial details to that of a user face model, and selecting a face seal designed specifically for that face model.

In some embodiments, the respiratory protective device may be modular and customizable. For example, a respiratory protective device kit may be customized by a user by adding additional components, selecting a face seal from the plurality of interchangeable face seals, and choosing a shell and shell cover design for the device.

The rigid or semi-rigid frame 112 provides structural integrity to allow for the attachment of other components such as the filter 108, liner 110, and shell 104, as examples. Examples of production methods for a face seal or frame include injection molding, transfer molding, fused filament fabrication, or blow molding. The rigid or semi-rigid frame 112 also provides attachment points for elastic harness straps 116 to transmit force via the face seal 114 to maintain an airtight seal with a user's face. In various exemplary embodiments, facepiece portions 112 and 114 may be removably attached or integrally combined in a permanent fashion. In exemplary embodiments, frame 112 may be sealably and removably attached to face seal 114 through an integral flange molded into a face seal such that a frame may closely appose and occupy the void space created by the molded flange, shown later in detail. In other embodiments, a frame 112 may contain features including molded concentric ridges or channels to improve sealing with filter 110 and/or face seal 114 by means of singular or multiple impinging surfaces causing deformation under pressure of the other component and creating a more tortuous sealing surface with increased surface area.

A filter 108 establishes a surface that partially defines the extent of the inner chamber and allows fluid communication between the outside environment and the user's respiratory tract. The filter 108 captures contaminants present in the air traversing in an inward direction, from the outer surface to the inner surface of the filter relative to the user's face, allowing for a breathing zone inside the inner chamber with a lower concentration of contaminants than the air in the surrounding environment. In some embodiments, the filter 108 may also capture contaminants present in the air traversing in the outward direction, from the inner surface to the outer surface of the filter relative to the user's face, allowing for capture of potential contaminants originating from within the inner chamber, including those emanating from the user. In some embodiments, a single exhalation valve or multiple exhalation valves (not shown) may be mounted to the filter through an aperture or apertures to enable the preferential flow of a portion of exhaled air through the valve, partially bypassing the filter. In those embodiments, the exhalation valve or valves are understood to recover the aperture or apertures present in the filter 108 and extend through the entire thickness of the filter and are designed to open and allow outward fluid flow when the inner chamber pressure exceeds that of the pressure outside the filter. In the embodiments that include an exhalation valve or valves, the user's exhaled air passes through the valve or valves and may be deposited into the second chamber located between the filter 108 and the shell 104 prior to movement across the shell and into the surrounding environment. In exemplary embodiments, the filter may be composed of a single layer or multiple layers of nonwoven textiles comprising inner, outer, and intermediate layers that may include electrostatic or non-electrostatic textiles that are molded to form a shape that is complementary to occupy the void space between the filter sealing ring 106 and the frame 112 while allowing sufficient space occupied by a user's face and nose.

A filter sealing ring 106 is sealably and removably attached to frame 112 and defines a void space between these two components in which a filter 108 is removably and sealably attached. In exemplary embodiments, a filter sealing ring may contain features including molded concentric ridges or channels to improve sealing with filter 110 and/or shell 104 by means of singular or multiple impinging surfaces causing deformation under pressure of the other component and creating a more tortuous sealing surface with increased surface area. Examples of manufacturing techniques for the production of a filter sealing ring include injection molding and CNC milling. A filter sealing ring may also incorporate an attachment mechanism comprising multiple latches that engage frame 112, allowing for pressure to be distributed over the extent of the surface of the filter sealing ring against the outer flange portion of the filter 108 and the frame.

A liner 110 composed in some embodiments of various textiles including knits, wovens, nonwovens, meshes, or spacer meshes may occupy a space in close apposition of the inside surface of the filter 108 and secured removably by the frame 112 and face seal 114. A liner may be positioned inside of a filter to act as a gas permeable barrier to particulates produced by the user, including respiratory aerosols generated during breathing, speaking, sneezing, or coughing. In an exemplary embodiment, a gas permeable liner composed of 3-dimensional knit textile or spacer mesh may contain surface finishes or yarn properties including hydrophilic, hydrophobic, antibacterial, antimicrobial, quick drying, catalytic, odor absorbing, or organic molecule binding. In such an embodiment, a liner may act as an inner prefilter to capture some particulate or gaseous matter generated by a user to prolong filter 108 life and prevent soiling of the filter by the user. In such an embodiment, liner 110 may be composed of a durable textile such as spacer mesh and be removable to enable a user to periodically clean said liner such as in a washing machine or by hand washing prior to drying and replacing said liner in the respiratory protective device 100. In some embodiments, a plurality of liners may be available to the user to facilitate changing out a soiled liner with a clean liner. In some embodiments, a liner may be formed into a three-dimensional shape such as to be in close apposition to the inner surface of a filter 108 by means of heat and pressure, such as in a heat press or through ultrasonic welding, and sized using various cutting methods such as die cut and laser cutting.

In some embodiments, a shell 104 and closely associated shell cover 102 are secured to a facepiece by removable attachment to a frame 112. The shell having a surface complementary to a frame enabling nonsealable or sealable attachment to said frame. In an exemplary embodiment, shell cover may be permanently bonded to a shell by various means, including thin film hot melt adhesive, liquid adhesive, spray adhesive, ultrasonic welding, stitching, or mechanical attachment using latches or circumferential ring (not shown). In such an embodiment, shell cover may be composed of various textiles, including knits, wovens, nonwovens, or spacer meshes. A shell cover may be attached to a shell by means of heat and pressure such as in a heat press beginning with a textile of a smaller, larger, or similar dimension (not shown) and through trimming to final size by processes including die cutting or laser cutting. An exemplary embodiment may include wrapping of a shell cover around the perimeter of a shell and securing to the under surface of the shell by means of liquid adhesive, ultrasonic welding, spray adhesive, or mechanical methods such as a trim ring or latches. In some embodiments, a shell 104 is comprised of a skeletonized portion allowing the mechanical support of a shell cover and also allowing fluid communication across the shell. In such an embodiment with a shell sealably attached to a facepiece and frame, said shell forms a surface creating a second chamber between the outside environment and the filter 108. In such embodiments, shell and shell cover may protect filter 108 from environmental effects and forces. In some embodiments, a shell cover may contain surface finishes or yarn properties including hydrophilic, hydrophobic, oleophobic, antibacterial, antimicrobial, quick drying, catalytic, odor absorbing, organic molecule binding, or anti-static. In an exemplary embodiment, a shell fabric may contain hydrophobic, oleophobic, superhydrophobic, superoleophobic, or antimicrobial yarn properties or surface finishes enabling the shedding of liquid state water such as from environmental rain or splashes, as well as shedding of other substances of varying viscosity, polarity, pH, or charge, including blood and other bodily fluids. In such an embodiment, shell and shell cover may act as both mechanical protection for filter 108 and user from objects or substances that may come in contact with and damage a filter, such as environmental rain or splashes. Shell and shell cover may also act as an external prefilter for filter 108 for some particulate or gaseous contaminants suspended in the surrounding air, including aerosols, dusts, dirt, metals, chemicals, or infectious organisms. In such an embodiment, shell 104 and shell cover 102 may help prolong the life of filter 108 by protecting said filter, including from various above-described hazards and factors that may shorten filter life. In some embodiments, shell and shell cover are removably attached to facepiece and frame 112 by means of latches, magnets, or bayonet-style attachment by means of lugs engaging a mating surface and capturing said mating surface through a rotating motion. In some embodiments, shell cover 102 may be produced with different materials or surface finishes to attempt to optimize shell properties for different users. Shell and shell cover may also be produced in different colors, patterns, or styles to meet varying functional and aesthetic needs of different users. In some embodiments, a shell may be detached from a facepiece and replaced with one of a different color, pattern, or style according to user preferences.

In one or more embodiments, an eye shield 118 is removable or permanently attached to a shell 104. Attachment of said eye shield to a shell may be accomplished through various removable means including magnets, latches, or capture by a groove or channel. Attachment of said eye shield to a shell may also be accomplished through various permanent means including liquid or spray adhesive, ultrasonic welding, overmolding, or other mechanical means. An eye shield may be composed of various transparent or translucent materials, including polyethylene terephthalate, polycarbonate, acrylic, or polystyrene. In an exemplary embodiment, said eye shield may have various coatings on the interior or exterior surfaces, including anti-scratch, hard-coat, anti-fog, mirror, and/or anti-reflective. In some embodiments, an eye shield may be produced and intended as a disposable or limited-reuse component, while in other embodiments, an eye shield may be produced with materials and processes to enable extended use and reuse of the eye shield. Some embodiments of an eye shield may incorporate tinting of various shades and colors for outdoor protection from the sun or other high brightness environments. In many embodiments, an eye shield may be comprised of multiple discrete surfaces including front and side surfaces, or utilizing a continuously curved shape to enable side or wraparound protection for the eyes, including against aerosols, infectious organisms, particulates, projectiles, or dusts. In some embodiments, an eye shield may be produced with materials and techniques enabling protection against projectile impact hazards. In most embodiments, an eye shield is permanently or removably attached to a shell 104 enabling a floating attachment away from the face to enable a user to also wear corrective eyewear, sun protective eyewear, safety glasses, safety goggles, or chemical/splash resistant goggles under said eye shield.

In many embodiments, harness straps 116 are attached to a facepiece enabling removable attachment of a respiratory protective device 100 over a user's mouth and nose. In some embodiments, two straps are utilized while in other embodiments, a single strap may be used. Harness strap material may include elasticized textiles and elastomeric materials such as rubber or silicone. Harness straps may mount to frame 112 by means of an interposed attachment mechanism such as a removable or permanently attached latch or pivot that may allow for adjustment by capturing a strap and allowing primarily unidirectional movement through the mechanism by pulling of the strap and resetting through moving aside a gripping surface on the adjustment mechanism. Certain embodiments may include latching buckles that enable the reversible breaking of a loop configuration of one or both harness straps. Some embodiments may include various shapes and configurations of harness straps, including an upper strap containing a ring comprised of similar or dissimilar material that is complementary to a user's head shape. Other embodiments may include harness straps that secure behind a user's ears and may include a further connecting strap that attaches to each harness strap and is located behind a user's head to help transmit pressure exerted on a user's ears by the harness straps to the back of the head or neck. Such an embodiment may include a connecting strap that is permanently or removably attached to the harness straps by means of single or multiple hook-and-loop fasteners, snaps, magnets, buckles, or catches. In other embodiments, a harness strap may include an adjustment mechanism allowing a user to change strap length to customize fit. In some embodiments, a harness strap may be configured to allow a strap to freely pass through an attachment point to allow a respiratory protective device to be positioned off of a user's face when so desired.

FIG. 2 illustrates an exemplary embodiment of an assembled respiratory protective device 100 including a shell with shell cover, harness straps, and an eye shield as worn in a typical fashion by a user 900. FIG. 3 illustrates a similar embodiment without an eye shield of a respiratory protective device 300 as worn in a typical fashion by a user.

FIG. 4 demonstrates an assembled respiratory protective device 400 without attached harness straps or shell. Face seal 114 is understood to be most proximal to a user's face. Frame 112 interfaces with face seal 114 in a permanent and integrated manner or a sealably removable manner. Filter sealing ring 106 is of a complementary shape to frame 112 and defines a void area when assembled to the frame. This void area is occupied by the circumferential flange portion of filter 108, which is removably held in place and forms a seal with said filter sealing ring and frame. Filter sealing ring 106 may removably attach to frame 112 through a primary and secondary filter sealing ring attachment mechanism 106-1 and 106-2. A filter sealing ring mechanism can include different mechanisms of removable attachment, including magnets or mechanical latches. Further, embodiments of frame 112 may include primary and secondary harness attachments 112-1 and 112-2. Embodiments of said harness attachments may include openings to allow for sliding capture of harness straps. Other embodiments of said harness attachments may contain a resettable mechanism for harness strap length adjustment.

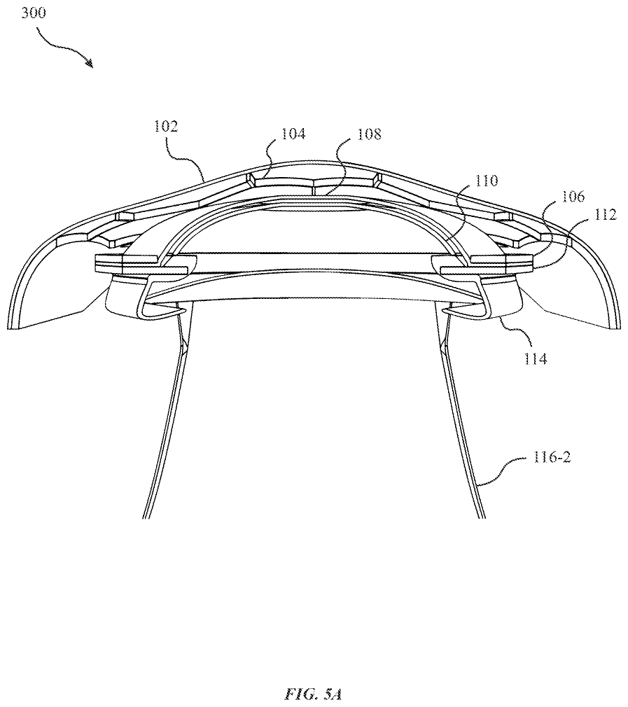

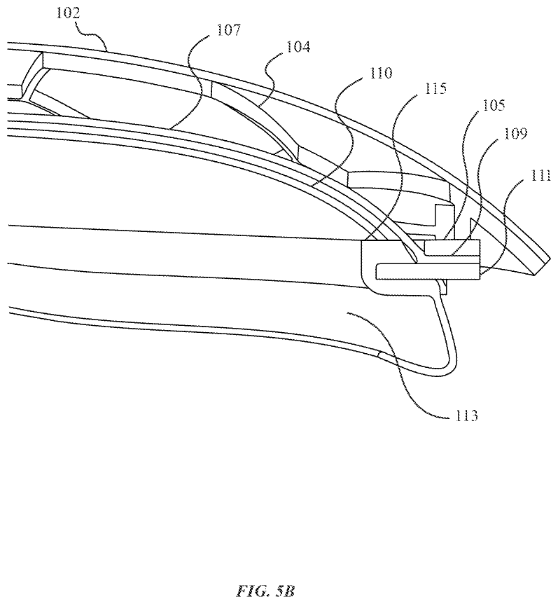

FIG. 5A shows a top cutaway view and FIG. 5B shows a side cutaway view of a respiratory protective device 300 without an attached eye shield. Shell cover 102 is shown in this embodiment in close apposition to shell 104, which contains a skeletonized and non-skeletonized section. A shell 104 may be removably and sealably or nonsealably attached to frame 112 through an attachment mechanism, such as tabs, latches, magnets, and other connectors or adhesives. In certain embodiments, the shell 104 may provide a void space between filter body 107 and the shell 104 or shell cover 102 to create a second chamber. Filter liner 110 may be removably inserted into some embodiments of the respiratory protective device, with a shape and size of the filter liner 110 complementary to an interior portion of the filter body 107 to enable close apposition of the filter liner 110 to the filter body 107. The filter liner 110 may be held in place by the frame body perimeter 111 of the frame 112 and/or a portion of the flange seal 115 of the face seal 114. The filter liner 110 may be coupled or placed into an after portion of the filter 108. In various embodiments, the filter liner 100 may be attached by means of clips, hook-and-loop, magnets, and/or seated in front of the face seal flange (e.g., between the flange and the filter).

The filter 109 may include a filter lip portion 109 extending around the periphery of the filter body 107. The filter lip portion 109 is held in place by the frame body perimeter 111 and the frame body perimeter 105. The frame body perimeter 111 and frame body perimeter 105 lock and seal the lip portion 109 of the filter 108 into a secured position.

In the exemplary embodiment, face seal 114 may be removably and sealably attached to frame 112 by means of a deformable flange 115. The flange 115 and the face seal body 113 form a recessed portion between the flange 115 and the face seal body 113 where the recessed portion fits with a portion of the frame body perimeter 111. Various face seals 114 may be used with the respiratory device where the face seal body has different sizes to accommodate the face size and shape of different users. However, each of the different sized face seals would have the same or identically shaped face seal flange 115. Using the same face seal flange 115, allows the same components of the respiratory device to be used with different face seals 114 for different face sizes and shapes. Secondary harness strap 116-2 is understood to attach to its secondary harness attachment (not shown).

A kit may be provided including one or more components of the respiratory protective device. The kit allows for the assembly of various components of the respiratory device. For example, a kit may include one or more of the following: a first frame 112 having a first body perimeter, the first body perimeter forming a first opening; a second frame 106 having a second body perimeter, the second body perimeter forming a second opening, the second frame 106 being removably attachable to the first frame 112; one or more filters 108, each filter having a filter body and a lip portion extending from the filter body, the filter 108 disposed between the first frame 112 and the second frame 106, wherein a surface of the first perimeter and a surface of the second perimeter engages the lip portion; and multiple face seals 114, wherein each face seal 114 has a body, the body forming a third opening and a flange 115 extending around the face seal 114, the face seal removably attachable to the first frame 112, wherein the flange 115 is shaped to fit within the opening of the first filter 110, and wherein at least two face seals 114 have different body shapes to fit different face sizes, and the flange 115 is the same size for each of the multiple face seals 114. In one example, the kit includes at least three different sized face seals 114 to accommodate small, medium and large sized faces. Each of the at least three different sized face seals 114 would have the same shaped and sized flange 115.

The kit may include one or more filter liners 110, where the filter liner 110 is configured to be removably attached to an aft interior portion of the one or more filters 108. The kit may also include one or more shells 104, where each shell 104 has a body with a recessed portion extending along an upper portion of a rear side of the shell 104. The kit may also include one or more eye shields 118, where each eye shield 118 having a lip portion formed to engage with the recessed portion of the shell 104. The kit may also include one or more shell coverings 102 attachable to a front side of the shell 104.

FIG. 6 demonstrates a typical configuration of a seal check apparatus 602 when attached to a respiratory protective device 400 without shell or harness straps illustrated for clarity. In some embodiments, a seal check apparatus may temporarily attach in a removable and sealable manner to a respiratory protective device in place of a shell. In some embodiments, a seal check apparatus may be rigid or semi-rigid and manufactured from thermoplastics, composites, textiles, or elastomeric materials. Said seal check apparatus may include an aperture located on the apex portion to enable a user to cover and uncover the aperture with a hand while breathing in or out to enable a user to perform a positive or negative pressure user seal check or to allow an external quantitative fit testing device to sealably attach to said aperture. Such a seal check apparatus may attach to a respiratory protective device by means of primary and secondary attachment points 602-1 and 602-2, which may enable attachment through magnets or latches. In some embodiments, a seal check apparatus is held in place by the user without the aid of an attachment mechanism. In other embodiments, a seal check apparatus may have a shape complementary to the external surface of a shell and positioned external to said shell so as to form a seal with the shell.

### REFERENCE NUMERALS

The following reference numerals are used to describe elements of respective components of the respiratory protective device.
100 Respiratory protective device
102 Shell cover
104 Shell (also referred to as outer shell)
105 Frame body perimeter
106 Filter sealing ring (includes frame body perimeter 105)
106-1 Primary filter sealing ring attachment mechanism
106-2 Secondary filter sealing ring attachment mechanism
107 Filter body
108 Filter (includes filter body 107 and filter lip portion 109)
109 Filter lip portion
110 Liner (also referred to as filter liner)
111 Frame body perimeter
112 Frame (includes frame body perimeter 111)
112-1 Primary harness attachment
112-2 Secondary harness attachment
113 Face seal body
114 Face seal (includes the face seal body 113 and the face seal flange 115)
115 Face seal flange
116 Harness straps
116-1 Primary harness strap
116-2 Secondary harness strap
118 Eye shield
300 Respiratory protective device example w/o eye shield
400 Respiratory protective device example w/o harness straps, shell, and shell cover
602 Seal check apparatus
602-1 Primary seal check apparatus attachment
602-2 Secondary seal check apparatus attachment
900 User

It will be appreciated that the present disclosure may include any one and up to all of the following examples:

Example 1: A respiratory protective device, comprising: a first frame 112 having a first body perimeter 111, the first body perimeter 111 forming a first opening; a second frame 106 having a second body perimeter 105, the second body perimeter 105 forming a second opening, the second frame 106 being removably attachable to the first frame 112; a filter 108 having a filter body 107 and a lip portion 109 extending from the filter body 107, the filter 108 disposed between the first frame 112 and the second frame 106, wherein a surface of the first body perimeter 111 and a surface of the second body perimeter 105 engages the lip portion 109; and a face seal 114 having a body 113, the body 113 forming a third opening and the body including a flange 115 extending around the face seal 114, the face seal 114 removably attachable to the first frame 112, wherein the flange 115 is shaped to fit within the opening of the first body perimeter 111.

Example 2: The device of Example 1, further comprising: an outer shell 104, having a body with a recessed portion extending along an upper portion of a rear side of the outer shell 104; and a shell covering 102 attached to a front side of the shell.

Example 3: The device of any of Example 1-2, further comprising: a eye shield 118 having a lip portion formed to engage with the recessed portion of the outer shell 104.

Example 4: The device of any of Examples 1-3, further comprising: a filter liner 110 removably attached to an aft interior portion of the filter 108.

Example 5: The device of any of Examples 1-4, wherein the first frame 112 and second frame 106 each comprising a plurality of connectors spaced about the first and second body perimeter.

Example 6: The device of any of Examples 1-5, comprising one or more void spaces formed between the first filter 110 and the outer shell.

Example 7: The device of any of Examples 1-6, wherein the outer shell has an interior portion configured to receive an assembled first and second frame.

Example 8: The device of any of Examples 1-7, wherein the flange 115 forms a recess extending around a perimeter of the face seal body, and a portion of the first frame 112 is configured to couple with the recess to hold the face seal body to the first frame 112.

Example 9: The device of any of Examples 1-8, wherein the filter liner 110 has a body perimeter that couples with a portion of the first frame and the flange 115 of the face seal 114.

Example 10: The device of any of Examples 1-9, wherein the outer shell 104 comprises a plurality of apertures formed within the body of the outer shell thereby allowing fluid communication between an external environment and the first filter 108.

Example 11: The device of any of Examples 1-10, further comprising a seal check apparatus comprising a conical flanged cover having an associated aperture, the seal check apparatus configured to sealably and detachably mate with a facepiece.

Example 12: A kit for respiratory protective devices, the kit comprising: at least one respiratory protective device comprising: first frame 112 having a first body perimeter, the first body perimeter forming a first opening; a second frame 106 having a second body perimeter, the second body perimeter forming a second opening, the second frame 106 being removably attachable to the first frame 112; one or more filters 108, each of filter having a filter body and a lip portion extending from the filter body, the filter 108 disposed between the first frame 112 and the second frame 106, wherein a surface of the first perimeter and a surface of the second perimeter engages the lip portion; and multiple face seals 114, wherein each face seal 114 has a body, the body forming a third opening and a flange 115 extending around the face seal 114, the face seal removably attachable to the first frame 112, wherein the flange 115 is shaped to fit within the opening of the first filter 112, and wherein at least two face seals 114 have different body shapes to fit different facial morphologies, facial geometries or facial features, and the flange 115 is the same size for each of the multiple face seals 114.

Example 13: The kit of Example 12, further comprising: one or more filter liners 110, the filter liner 110 configured to be removably attached to an aft interior portion of the one or more filters 108.

Example 14: The kit of any of Examples 12-13, further comprising: one or more shells 104, each shell 104 having a body with a recessed portion extending along an upper portion of a rear side of the shell 104.

Example 15: The kit of any of Examples 12-14, further comprising: one or more eye shields 118, each eye shield 118 having a lip portion formed to engage with the recessed portion of the shell 104.

Example 16: The kit of any of Examples 12-15, further comprising: one or more shell coverings 102 attachable to a front side of the shell 104.

Example 17: A respiratory protective device, comprising: a facepiece; a first filter; an outer shell; a first chamber, wherein the first chamber comprises a first void space formed by a face of a user, the facepiece and the first filter, wherein the first void space extends from the face of the user to the first filter; a second chamber, wherein the second chamber comprises a second void space formed between the first filter and the outer shell; a frame positioned between said first chamber and said second chamber, wherein the frame joins the facepiece to the outer shell; a sealing ring positioned between the frame and the outer shell, wherein the sealing ring holds the first filter in contact with the frame, forming a seal; and a filter liner, removably attached to the first filter on a surface facing the first chamber, wherein the filter filter is removable while retaining a seal separating the first chamber and the second chamber.

Example 18: The respiratory protective device of Example 17, wherein the facepiece is removably attached to the frame.

Example 19: The respiratory protective device of any of Examples 17-18, wherein a plurality of alternate facepieces 114, each of a different design or size, are interchangeable with the facepiece 114 and configured to be removably attached to the frame 112.

Example 20: The respiratory protective device of any of Examples 17-19, wherein the first filter comprises a filter body and a lip portion extending from the filter body, the filter disposed between the frame and the outer shell, wherein a surface of the frame and a surface of the outer shell engages the lip portion.

Example 21: The respiratory protective device of any of Examples 17-20, wherein the sealing ring is removably attached to the outer shell and wherein the lip portion is engaged by the frame and the sealing ring attached to the outer shell.

Example 22: The respiratory protective device of any of Examples 17-21, wherein the outer shell comprises: a body with a recessed portion extending along an upper portion of a rear side of the outer shell, wherein a eye shield is removably attached at the recessed portion of the outer shell, the eye shield having a lip portion formed to engage with the recessed portion of the outer shell; and one or more shell coverings attachable to a front side of the outer shell.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

The terminology used herein is for the purpose of describing particular aspects only and is not intended to be limiting of the disclosure. As used herein, the singular forms “an” and “the” are intended to comprise the plural forms as well, unless the context clearly indicates otherwise. It will be further understood that the terms “comprises,” comprising,” or a combination thereof, when used in this specification, specify the presence of stated features, integers, steps, operations, elements, and/or components, but do not preclude the presence or addition of one or more other features, integers, steps, operations, elements, components, and/or groups thereof.

Although the previous disclosure has been described in detail by illustration and example for purposes of clarity and understanding, it should be recognized that the above disclosure can be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the following claims.

What is claimed is:

1. A respiratory protective device, comprising:
a first frame having a first body perimeter, the first body perimeter forming a first opening;
a second frame having a second body perimeter, the second body perimeter forming a second opening, the second frame being removably attachable to the first frame;
a filter having a filter body and a lip portion extending from the filter body, the filter disposed between the first frame and the second frame, wherein a surface of the first body perimeter and a surface of the second perimeter engages the lip portion; and
a face seal having a body, the body forming a third opening and including a flange extending around the face seal, the face seal attaches to the first frame, wherein the flange is shaped to fit within the opening of the first body perimeter.

2. The device of claim 1, further comprising:
an outer shell having a body with a recessed portion extending along an upper portion of a rear side of the outer shell; and
an outer shell covering attached to a front side of the outer shell.

3. The device of claim 2, further comprising:
an eye shield having a lip portion formed to engage with the recessed portion of the outer shell.

4. The device of claim 1, further comprising:
a filter liner removably coupled to an aft interior portion of the filter.

5. The device of claim 1, wherein the first frame and second frame each comprising a plurality of connectors spaced about the first and second body perimeter.

6. The device of claim 1, comprising one or more void spaces formed between the first filter and the outer shell.

7. The device of claim 1, wherein the outer shell has an interior portion configured to receive an assembled first and second frame.

8. The device of claim 1, wherein the flange forms a recess extending around a perimeter of the face seal body, and a portion of the first frame is configured to couple with the recess to hold the face seal body to the first frame.

9. The device of claim 1, wherein the filter liner has a body perimeter that couples with a portion of the first frame and the flange of the face seal.

10. The device of claim 2, wherein the outer shell comprises a plurality of apertures formed within the body of the outer shell thereby allowing fluid communication between an external environment and the first filter.

11. The device of claim 1, further comprising:
a seal check apparatus comprising a conical flanged cover having an associated aperture, the seal check apparatus configured to sealably and detachably mate with a facepiece.

12. A kit for respiratory protective devices, the kit comprising:
at least one respiratory protective device comprising:
a first frame having a first body perimeter, the first body perimeter forming a first opening;
a second frame having a second body perimeter, the second body perimeter forming a second opening, the second frame being removably attachable to the first frame;
one or more filters, each filter having a filter body and a lip portion extending from the filter body, the filter disposed between the first frame and the second frame, wherein a surface of the first perimeter and a surface of the second perimeter engages the lip portion; and
multiple face seals, wherein each face seal has a body, the body forming a third opening and a flange extending around the face seal, the face seal removably attachable to the first frame, wherein the flange is shaped to fit within the opening of the first body perimeter, and wherein at least two face seals have different body shapes to fit different facial morphologies, and the flange is the same size for each of the multiple face seals.

13. The kit of claim 12, further comprising:
one or more filter liners, the filter liner configured to be removably coupled to an aft interior portion of the one or more filters.

14. The kit of claim 12, further comprising:
one or more shells, each shell having a body with a recessed portion extending along an upper portion of a rear side of the shell.

15. The kit of claim 14, further comprising:
one or more eye shields, each eye shield having a lip portion formed to engage with the recessed portion of the shell.

16. The kit of claim 14, further comprising:
one or more shell coverings attachable to a front side of the shell.

17. A respiratory protective device, comprising:
a face seal;
a first filter;
an outer shell;
a first chamber, wherein the first chamber comprises a first void space formed by a face of a user, the face seal and the first filter, wherein the first void space extends from the face of the user to the first filter;
a second chamber, wherein the second chamber comprises a second void space formed between the first filter and the outer shell;
a frame positioned between said first chamber and said second chamber, wherein the frame joins the facepiece to the outer shell;
a sealing ring positioned between the frame and the outer shell, wherein the sealing ring holds the first filter in contact with the frame, forming a seal; and
a filter liner, removably attached to the first filter on a surface facing the first chamber, wherein the filter liner is removable while retaining a seal separating the first chamber and the second chamber.

18. The respiratory protective device of claim 17, wherein the face seal is removably attached to the frame.

19. The respiratory protective device of claim 18, wherein a plurality of alternate face seals, each of a different design or size, are interchangeable and configured to be attached to the frame.

20. The respiratory protective device of claim 17, wherein the first filter comprises a filter body and a lip portion extending from the filter body, the first filter disposed between the frame and the outer shell, wherein a surface of the frame and a surface of the outer shell engages the lip portion.

21. The respiratory protective device of claim 20, wherein the sealing ring is removably attached to the outer shell and wherein the lip portion is engaged by the frame and the sealing ring attached to the outer shell.

22. The respiratory protective device of claim 17, wherein the outer shell comprises:
a body with a recessed portion extending along an upper portion of a rear side of the outer shell, wherein a eye shield is removably attached at the recessed portion of the outer shell, the eye shield having a lip portion formed to engage with the recessed portion of the outer shell; and
one or more shell coverings attachable to a front side of the outer shell.
